(19) United States
(12) Patent Application Publication
(10) Pub. No.: US 2020/0380627 A1
(43) Pub. Date: Dec. 3, 2020

(54) DYNAMIC EVALUATION AND SELECTION FOR DOCUMENT VALIDATION

(71) Applicant: Capital One Services, LLC, McLean, VA (US)

(72) Inventors: Daniel Alan Jarvis, McLean, VA (US); Jason Pribble, McLean, VA (US); Nicholas Capurso, McLean, VA (US)

(73) Assignee: Capital One Services, LLC, McLean, VA (US)

(21) Appl. No.: 16/426,774

(22) Filed: May 30, 2019

(51) Int. Cl. G06Q 50/26; G06F 16/93

(52) U.S. Cl. CPC G06Q 50/265; G06F 16/93

(57) ABSTRACT

Disclosed herein are system, method, and computer program product embodiments for routing a document validation request to one or more validation service providers. In an embodiment, selections of validation service providers are based dynamically evaluations that take into consideration validation results among other factors. Evaluations of the service providers enables the service providers to be ranked across different characteristics and selection may therefore be based on the specific document included in the document validation request.

### BACKGROUND

Some entities, such as financial institutions, banks, and the like, utilize certain documents to verify the identity of users. For example, an entity may receive an identification document (e.g., government-issued identification (ID) cards) from a user device as part of an attempted transaction. Authorization of the transaction may depend on verifying the identity of the user attempting to make the transaction. Accordingly, the entity may then forward the identification document to a single document validation service provider for validation of the identification document.

### BRIEF DESCRIPTION OF THE DRAWINGS

The accompanying drawings are incorporated herein and form a part of the specification.

FIG. 1 depicts a block diagram of a system that includes evaluation middleware and multiple document validation service providers, according to some embodiments.

FIG. 2 depicts a block diagram illustrating some components of an evaluation middleware, according to some embodiments.

FIG. 3 depicts a flow diagram illustrating a flow for selecting a document validation service provider, according to some embodiments.

FIG. 4 depicts a flow diagram illustrating a flow for updating an evaluation model for multiple document validation service providers, according to some embodiments.

FIG. 5 depicts an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for dynamically evaluating validation service providers based on validation results among other factors and selecting an appropriate validation service provider for document validation based on the evaluation. Different validation service providers may be better at validating certain documents than others but conventional processing of validation requests lacked intelligent routing of validation requests to ensure accurate and efficient validation of each document. Validation systems are generally limited to this arrangement because entities lacked means for accurately evaluating and ranking validation service providers based on the number of different parameters associated with the validation service results provided by each provider such as the document type, document quality, user device information, and document characteristics.

By relying on a dynamically updated evaluation model, embodiments of the present disclosure improve existing computer systems by providing ranked evaluations of multiple document validation service providers. And the evaluation model can be tuned based on properties of the document such that each document validation service provider can be evaluated not just based on the document itself but, in a more granular manner, based on specific properties of the document. Accordingly, embodiments of the present disclosure enable systems to dynamically adjust how validation requests are routed by selecting service providers based on their evaluations for specific properties of documents associated with the requests.

In an embodiment, an evaluation middleware system may receive document validation requests from a device, such as a user device, that include the document to be validated. Instead of being tied to a single validation service provider, evaluation middleware system connects with a plurality of validation service providers and selects a validation service, based on evaluations associated with each validation service provider, to which the document request and document are routed for validation. These evaluations may be generated and subsequently updated based on the validation results provided by each validation service provider along with any number of factors associated with the document request and document. These factors may be provided or retrieved from a number of different sources including the document itself, characteristics associated with the document, information associated with user devices that transmitted the document validation request, and information associated with a user account of a mobile application installed on the user device.

Basing evaluations on these factors enable the evaluation middleware system to organize and rank validation service providers at various levels of granularity. For example, validation service providers can be evaluated based on document validation results for a specific document type (e.g., a driver license) and then ranked based on those evaluations. Undergoing this evaluation process may then allow evaluation middleware system to select a validation service provider for validating the document.

In view of the foregoing description and as will be further described below, the disclosed embodiments allow an evaluation middleware system to determine a validation service provider that is best suited for validating a particular document in a document validation request. In particular, the evaluation and selection process enable document validation requests to be routed in an efficient and cost-effective manner while ensuring that the request will be serviced accurately by the selected validation service provider. By monitoring characteristics and validation results associated with each document validation request, evaluation middleware system may make more intelligent decisions regarding to which service provider a document validation request should be routed. In this manner, the described embodiments result in a faster and more accurate validation process.

Various embodiments of these features will now be discussed with respect to the corresponding figures.

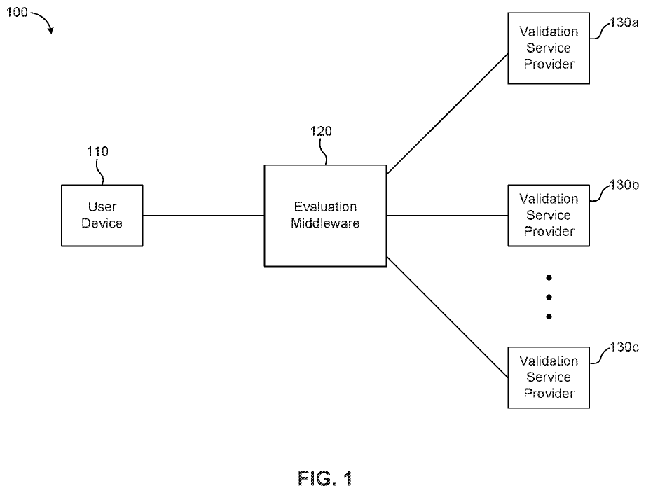

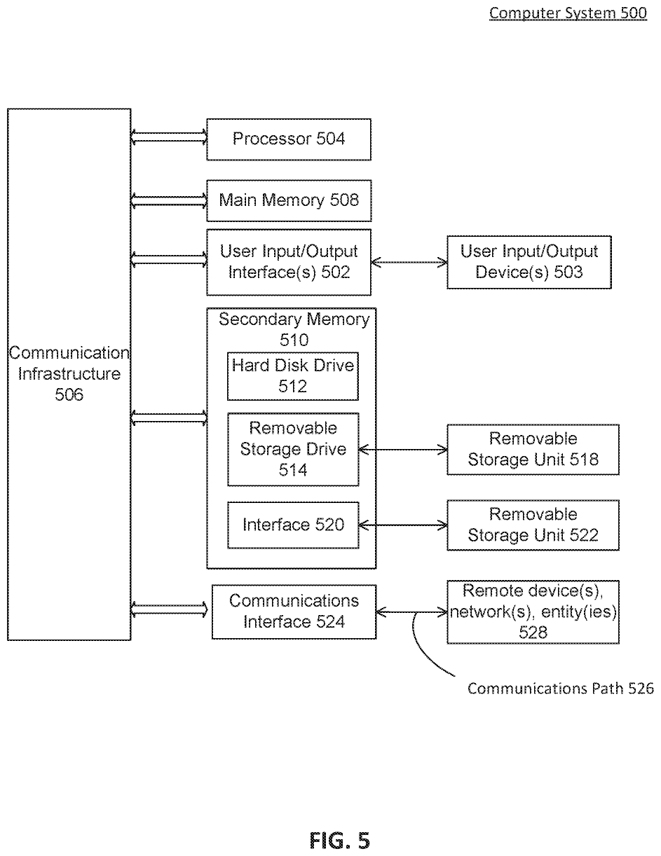

FIG. 1 is a diagram of an example environment 100 in which systems and/or methods, described herein, may be implemented. Environment 100 may include a user device 110, an evaluation middleware system 120, and a plurality of validation service providers 130a-n. Devices of the environment 100 may interconnect via wired connections, wireless connections, or a combination of wired and wireless connections. Devices of environment 100 may include a computer system 500 shown in FIG. 5, discussed in greater detail below.

User device 110 may include a device, such as a mobile phone (e.g., a smart phone, a radiotelephone, etc.), a laptop computer, a tablet computer, a handheld computer, a gaming device, a wearable communication device (e.g., a smart wristwatch, a pair of smart eyeglasses, etc.), or a similar type of device that is capable of communicating a document to a network device for validation. In some embodiments, user device 110 may include a global position system (GPS) sensor used for tracking a location of user device 110 and a wireless interface for establishing a wireless connection of user device 110 (e.g., a public network, an office network, or a home network).

User device 110 may also include an image capture device, such as a camera, for capturing an image of, for example, an identification document. The image capture device may support capturing images in one or more image resolutions. In some embodiments, an image resolution may be represented as a number of pixel columns (width) and a number of pixel rows (height), such as 1280×720, 1920×1080, 2592×1458, 3840×2160, 4128×2322, 5248×2952, 5312×2988, or the like, where higher numbers of pixel columns and higher numbers of pixel rows are associated with higher image resolutions. In some embodiments, the image capture device may support a first image resolution that is associated with a quick capture mode, such as a low image resolution for capturing and displaying low-detail preview images on a display of the user device. In some embodiments, the image capture device may support a second image resolution that is associated with a full capture mode, such as a high image resolution for capturing a high-detail image. In some embodiments, the user device 110 may send the captured image, via the network 125, to evaluation middleware system 120 for selection of an appropriate validation service provider to validate the document that is visible in the captured image.

In some embodiments, user device 110 may also include one or more mobile applications. For example, the one or more mobile applications may include a mobile application associated with and/or provided by an operator of evaluation middleware system 120, a financial institution, or a bank. In some embodiments, user device 110 may send a request to evaluation middleware system 120 to access information associated with an account such as a financial account or a bank account. As a part of the request, evaluation middleware system 120 may issue an identity challenge that results in a prompt to be displayed via the mobile application on user device 110 requesting the capture of an image of a document such as a government-issued identification document such as a driver license, passport, social security card, military identification, permanent residency card, employment authorization card, and travel authorization document (e.g., VISA) or other forms of identification such as an insurance card, healthcare card, debit or credit card, and a utility bill.

In some embodiments, the mobile application may include image capabilities and responsive to the identity challenge, the mobile application may activate the image capture device to capture an image of a document that is within visible proximity of user device 110. The image capabilities may include, but are not limited to, image processing and image analysis. In some embodiments, image processing refers to pre-capture functions that may be used to control image capturing, such as lighting (e.g., flash), zoom, and focus, before an image is captured by the image capture device. In some embodiments, image analysis refers to post-capture functions that may be used to determine properties of an image (e.g., brightness levels, glare level, light color profiles) after it has been captured by the image capture device. These properties may be determined based on post-capture analysis to determine for example that the background of the image is light or dark or that portions of the image have glare. The mobile application may store image information from image processing and image analysis with the captured image such that the image information is transmitted with the captured image when transmitted to evaluation middleware system 120.

In some embodiments, image analysis may include object detection. For example, the mobile application may also include object detection capabilities in order to detect information about the environment in which the image was captured. For example, the mobile application may detect a table or fabric as part of the background of the image which may indicate that the image of the document was captured while the document was on a table or on table cloth.

In some embodiments, other information may be associated with a captured information such as a GPS location provided by the GPS sensor and the type of transaction associated with a document validation request transmitted from user device 110 to evaluation middleware system 120 that initiated the identity challenge from evaluation middleware system 120.

The mobile application may store all information in capture profiles on user device 110. In some embodiments, capture profiles may organize historical information associated with a particular parameter. For example, a capture profile may be created for government-issued identification documents and may include information associated with all government-issued identification documents. As another example, a capture profile may store information associated with images captured at a particular location where images are taken or based on the type of documents. For example, a capture profile may be created for images or documents associated with a user's home location (or another specific GPS coordinate) and the profile can include information associated with the images or documents taken at that home location. Capture profiles may be used to increase the efficiency by which the mobile application can process or analyze documents captured by the image capture device. In some embodiments, user device may provide the capture profiles to evaluation middleware system 120 for storage and for use as part of and increasing the efficiency of the evaluation process. For example, a capture profile for a specific driver license may include all images taken by user device 110 of that specific driver license. Because those images are known to be associated with the same document, the images may be used in an evaluation process as a training set for that particular document.

When the mobile application is associated with a financial institution or a bank, in some embodiments, images of documents having sensitive information may be captured via the mobile application. Due to these potential security concerns, the image capabilities of mobile application may include security features not found in conventional imaging applications. For example, the mobile application may automatically delete any captured images after they are sent to evaluation middleware system 120. Another feature may include protecting the captured images when stored on user device 110 such as through encryption of captured images and/or analyzing of the captured information for sensitive information (e.g., social security information, address information) prior to storage in a memory of user device 110. Analyzing may include determining the presence of the sensitive information and then taking steps to protect that information such as through redaction or blurring of the sensitive information. Another feature may include timed storage and deletion of the captured image from user device 110. For example, the mobile application may store the captured image for 30 minutes subsequent to transmission to evaluation middleware system 120 in case the captured image needs to be resent (e.g., due to a failed transmission).

In communicating with evaluation middleware system 120, user device 110 may transmit a document validation request that includes a document to be validated. In some embodiments, the document is an image of the document to be validated. As noted above, in some embodiments, the document may be represented by an image captured by a mobile application on user device 110. In some embodiments, the document validation request is in response to an identity challenge transmitted by evaluation middleware system 120. In some embodiments the identity challenge may be in response to a transaction request from user device 110 to perform a transaction at evaluation middleware system 120. For example, the transaction request may be to access a financial account associated with a user of user device 110 and that is managed by an operator of evaluation middleware system 120.

Evaluation middleware system 120 may include a server device (e.g., a host server, a web server, an application server, etc.), a data center device, or a similar device, capable of communicating with the user device 110 via a network. The network may include one or more wired and/or wireless networks. For example, the network may include a cellular network (e.g., a long-term evolution (LTE) network, a code division multiple access (CDMA) network, a 3G network, a 4G network, a 5G network, another type of next generation network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, and/or the like, and/or a combination of these or other types of networks.

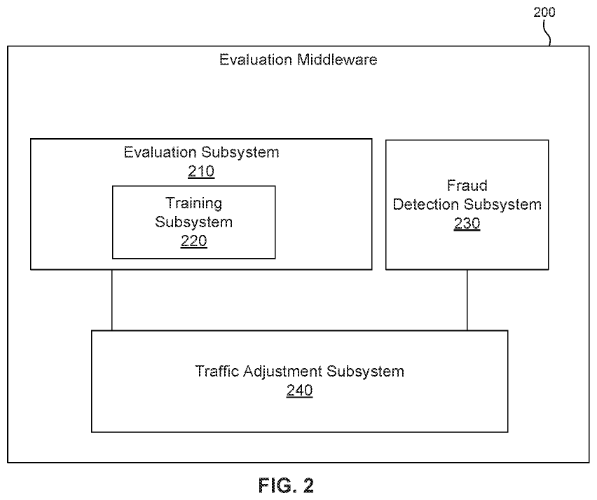

As discussed further with respect to FIG. 2, evaluation middleware system 120 include components for receiving a document validation request from user device 110 and, based on the document in the document validation request, selecting a validation service provider from the plurality of validation service providers 130a-n.

Evaluation middleware system 120 may receive document validation requests from user device 110. The document validation requests may include a document or an image of the document. In some embodiments, responsive to receiving a document validation request, evaluation middleware system 120 may determine a characteristic of the document such as by extracting information from an image; the characteristic may include a type of the document such as whether the document is a government-issued identification document, the government that issued the government-issued identification document. In some embodiments, the extracting may be performed by the mobile application at user device 110 and the characteristic(s) is provided as part of the document validation request.

In some embodiments, when the document is an image, the characteristic may include image information associated with the image including a location where the image was taken, a glare profile, and a color profile. Location may be attached to the image by mobile application using a GPS sensor of user device 110. The glare profile may indicate the amount of glare or brightness present in areas of the image. For example, the glare profile may be represented by a value or values that indicates that certain pixels in the image have glare or brightness (e.g., through a glare detection function of the mobile application). In some embodiments, glare in pixels may be determined based on detecting red, green, and blue (RGB) values in each pixel and determining whether the values are greater than a certain threshold value. For example, a value above the threshold may represent a difference in brightness between different areas in the image. In some embodiments, a color profile of an image includes color information about the colors in an image. For example, the color information may provide information about pixels and their associated colors in the form of values within an RGB color space, where each pixel's red, green, and blue values are each represented by a value. In some embodiments, the mobile application analyzes the image to determine the image information, including the glare and color profiles, which is then included in the document validation request that is transmitted to evaluation middleware system 120.

In some embodiments, the characteristic may include a capture profile that is provided with the document in the document validation request. Capture profiles include historical information associated with a particular context including a user name signed into the mobile application, user device 110 or the document that is included in the document validation request (e.g., a capture profile associated with government-issued identification documents). This context may be determined based on information or the document from the document validation request. For example, a user name signed into the mobile application on user device 110 may be included in the document validation request.

In some embodiments, document characteristics as discussed above, such as the document type (e.g., government-issued identification document), document information (e.g., whether the document has been issued by a particular state such as Ohio or New York), document properties (e.g., image information), may be used to categorize or otherwise organize validation results received from validation service providers such as validation service providers 130a-n. Validation service providers 130a-n may include a server device (e.g., a host server, a web server, an application server, etc.), a data center device, or a similar device, capable of communicating with the evaluation middleware system 120.

Validation results indicate the result of a validation service provider's validation process. Examples of validation results include whether the validation was successful, unsuccessful, or inconclusive (or unknown). In some embodiments, a successful validation result means that the validation service provider successfully determined that the provided document is an authentic identification document. An unsuccessful validation result may mean that the attempt to validate the provided document was unsuccessful; this may mean that the document is fraudulent or not an authentic document; for example, when the document is a driver license issued by Ohio, an unsuccessful validation may indicate that the document is a fake license and not an authentic Ohio driver license. And an inconclusive or unknown result may mean that the validation service provider was unable to determine whether the document was authentic or fake. An inconclusive result may stem from an issue with the provided document; for example, when the document is an image, the image may not include a full view of the document, may include image artifacts such as brightness or pixilation that prevented detecting the authenticity of the document.

Organizing validation results based on document characteristics allow embodiments of the present disclosure to rank validation service providers using different levels of granularity. In some embodiments, this allows evaluation middleware system 120 to rank validation service providers based on successful, unsuccessful, and inconclusive results of one or more characteristics. For example, validation service providers may be ranked based on how well the providers performed on specific types of documents (e.g., Ohio driver licenses, New York driver licenses), specific image information (e.g., a glare profile, a color profile), specific locations where an image was taken (e.g., certain GPS coordinates, a specific room in a house), or device type (e.g., mobile devices, tablets), device manufacturer, customer or user information, and operating system information. In other words, evaluation middleware system 120 may generate or have access to a number of different rankings that are tied to a specific document characteristic or characteristics.

A ranking may be based on an evaluation of each validation service provider. In some embodiments, this evaluation may be based on the validation results provided by each validation service provider and the document characteristic or characteristics that were associated with those validation results. As one example, an evaluation may indicate a particular document validation service provider's performance for particular document characteristics. This evaluation could be represented by the total number of successful validation results, unsuccessful validation results, and inconclusive validation results for a particular document characteristic. As another example, the evaluation may indicate, as a percentage, the ratio of successful validation results, unsuccessful validation results, and inconclusive validation results to the total number of requests sent to that validation service provider.

In some embodiments, each validation service provider's evaluation may be represented by an evaluation metric such as a number or some other value that is generated through an evaluation or training model in evaluation middleware system 120. As one example, the evaluation model may utilize machine learning to process the parameters involved in the evaluation process. The evaluation model may comprise one or more tiers of models. For example, the evaluation model may employ a first level evaluation model that receives, as inputs, any number of parameters including the validation results from the validation service provider, documents associated with the validation results, and document characteristics associated with the validation results. If the document is formatted as an image, the evaluation model may include a second level evaluation model that is tuned specifically to process images. In some embodiments, the first level and second level evaluation models may be implemented as neural networks. The output of the evaluation model may be an evaluation metric such as a particular value (or values) that represents the validation service provider's proficiency with processing certain documents. In some embodiments, the value or values provided by the evaluation model may then be used to rank the validation service providers.

When a validation result from a validation service provider involves a document that includes more than one characteristic (e.g., an Ohio driver license with a specific glare profile), the ranking may be based on one or more of those characteristics. For example, evaluation middleware system 120 may generate a separate ranking for each characteristic, such as one that ranks the validation service provider based on the Ohio driver license and another based on the specific glare profile. As another example, a single ranking may be generated based on one or more of the characteristics where each characteristic may be assigned a particular weight as part of the evaluation process. For example, the document type may be weighted more heavily than other characteristics.

In some embodiments, the evaluation model may be based on a decision tree (instead of or in addition to the ranking calculation discussed above). In an embodiment, the decision tree may be trained based on information associated with previously transmitted document validation requests and corresponding validation results. For example, any number of known inputs (from document validation requests) and known outputs (from the corresponding validation results) may be provided to a decision tree. The decision tree may generate the evaluation model based on determining an association based on the inputs and outputs. For example, the decision tree may determine that certain inputs (e.g., document type, device type) result in specific outputs (e.g., positive validation result, negative validation result) based on certain validation service providers. The evaluation model includes information that links these inputs to those outputs for each validation service provider. Accordingly, inputs associated with subsequent document validation requests may be provided to the evaluation model which then provides one or more validation service providers to service the document validation request.

In some embodiments, the evaluation model may be updated in real-time as validation results are received from validation service providers. In other embodiments, updates to the evaluation model may occur on a periodic or scheduled basis such as on a daily basis at a scheduled time. In other embodiments, updates to the evaluation models may occur when a threshold number of validation results have been received for a validation service provider or providers. In some embodiments, the evaluations may be based on any combination of the above.

Accordingly, based on the characteristic associated with the document, evaluation middleware system 120 may retrieve a ranking of validation service providers where the ranking is associated with that particular characteristic. For example, if the document is an image of an Ohio driver license, evaluation middleware system 120 may retrieve (or generate) a ranking of validation service providers associated with Ohio driver licenses.

Evaluation middleware system 120 may then select a validation service provider based on the ranking and/or a traffic adjustment parameter. The traffic adjustment parameter enables evaluation middleware system 120 to tune the selection to prevent all document validation requests from being sent to the highest ranked service provider. In some embodiments, the traffic adjustment parameter may define a specific ratio or weight of traffic to be sent to validation service providers on the ranked list based on their ranking. In other words, instead of always selecting the highest ranked validation service provider for a particular document or document type, the traffic adjustment parameter may dictate that evaluation middleware system 120 occasionally forward document validation requests lower (or the lowest ranked) validation service provider on the ranked list. For example, the ratio may indicate a weighted amount of traffic to be sent to each validation service provider such as 70% of document validation requests (for a particular a characteristic or characteristics) should be sent to the highest ranked validation service provider, 15% to the next ranked validation service provider, 5% to the next ranked validation service provider, and so on. In some embodiments, the ratio may be based directly or indirectly on an output of the evaluation model. For example, an output of the evaluation model may be generated based on inputs such as the document and validation results. In some embodiments, that output may be an evaluation metric such as a value or number for each validation service provider. For example, an evaluation metric for one validation service provider may be 0.70, 0.15 for another, and 0.05 for another. In some embodiments, these metrics may be used directly as the traffic adjustment parameter for weighting the amount of document validation requests to be sent to each validation service provider (instead of sending all document validation requests to the highest ranked validation service provider).

The benefit of this approach enables evaluation middleware system 120 to continuously monitor all validation service providers, update the rankings based on evaluations of all validation service providers, and determine whether historically lower performing validation service providers are improving.

In other embodiments, the traffic adjustment parameter may be based on a schedule such as specifying that document validation requests are sent to lower ranked service providers on a weekly or monthly basis. In other embodiments, the traffic adjustment parameter may divide the ranking into different tiers and provide a ratio or schedule to send requests to validation service providers within each tier. Yet in other embodiments, the traffic adjustment parameter may indicate that a request should be sent concurrently to all service providers in order to evaluate validation results from the service providers based on the same document. This request may be based on a schedule (such as once a month) to avoid sending too many requests to service providers which would incur additional costs. In some embodiments, after selection of a validation service provider or providers, evaluation middleware system 120 may then route the document validation request to the selected validation service provider.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of the environment 100 may perform one or more functions described as being performed by another set of devices of the environment 100.

FIG. 2 depicts a block diagram illustrating some components of an evaluation middleware system 200, according to some embodiments. Evaluation middleware system 200 may include evaluation subsystem 210, training subsystem 220, fraud detection subsystem 230, and traffic adjustment subsystem 240.

In some embodiments, evaluation subsystem 210 may be a component that performs various steps of an evaluation process for evaluating and ranking validation service providers. In some embodiments, evaluation subsystem 210 may include training subsystem 220 which is the component that receives inputs for the evaluation process and provides an output based on the received inputs. In some embodiments, the output may be an evaluation metric of validation service providers organized based on the evaluation metrics. Evaluation metrics may be a value or number that represents a validation service provider's proficiency with validating certain documents and could be represented by a weight or ratio of the validation service provider in comparison to other service providers with regard to the particular document characteristic or characteristics. For example, an evaluation metric for three validation service providers may be a weighted score or confidence value such as 0.80 for validation service provider 130a, 0.10 for validation service provider 130b, and 0.10 for validation service provider 130n. These weighted scores could then be used in ranking the validation service providers and also as a factor in the traffic adjustment parameter. The evaluation process may be implemented as an evaluation model for receiving the inputs and providing the output.

In some embodiments, evaluation subsystem 210 may also be responsible for issuing identity challenges in response to receiving transaction requests from user devices. For example, a transaction request may be a request transmitted via an application on user device 110 to access a user account associated with a username signed into the application. Prior to allowing access to the user account, evaluation subsystem 210 may transmit an identity challenge to user device 110. The identity challenge represents a request for user device 110 to provide a document that includes an identity of the user that submitted the transaction request. Accordingly, in some embodiments, document validation requests from user device 110 may be transmitted in response to the identity challenge.

Training subsystem 220 may employ machine learning to update the evaluation model based on updated inputs such as recent validation results and recent document validation requests. In some embodiments, training subsystem 220 may be implemented as one or more evaluation models that processes the received inputs and generates the output. In some embodiments, these evaluation models may be implemented as neural networks. There may be a neural network tuned to process different types of inputs. For example, one neural network may be employed for processing images; another neural network may be employed for other non-image information such as information included in a document validation request or validation result, document type, device information (e.g., information regarding the device accelerometer, device manufacturer, operating system version (e.g., Android 6.0, iOS 13), camera hardware capabilities such as focal length), user account information (e.g., billing address, ZIP code, age), image information associated when the document is provided as an image,.

In an embodiment when the evaluation model is implemented as a neural network, information may be converted into numerical values prior to being used as inputs into the neural network. For example, image data may be converted into pixel data and document information may be converted into a numerical value based on an algorithm or other process.

In some embodiments, training subsystem 220 receives a training set and is then trained to determine the performance of validation service providers across different parameters including the type of document, the characteristics of the document, among others. The training set may include prior validation results from the validation service provider, the documents that were validated, information about the document such as the document type, image information (when the document is represented as an image), device information, user information, and fraud reports associated with the document.

Training subsystem 220 may provide an output based on the training set that correlates to the validation service provider's performance. Accordingly, the output may be one or more evaluation metrics (or values) that represent the evaluation of the validation service provider, where each evaluation metric is associated with a particular parameter (e.g., document type).

In other embodiments, evaluation subsystem 210 may perform operations discussed above with respect to training subsystem 220. Evaluation subsystem 210 may be responsible for storing the evaluations and rankings and also retrieving the evaluations and rankings when a document validation request is received by evaluation middleware system 120. Evaluation subsystem 210 may also receive validation results from each of the validation service providers and stores these validation results to be used in future evaluations.

In some embodiments, fraud detection subsystem 230 may receive fraud reports that indicate a particular document has been associated with fraudulent activity. For example, a fraud report may be generated when a user reports fraudulent activity via fraud detection subsystem 230. In some embodiments, fraud detection subsystem 230 may be implemented as a system separate from but still connected to evaluation middleware system 200. Fraud detection subsystem 230 may then provide, as an input, the fraud report to evaluation subsystem 210 to be used to generate or update the evaluations and rankings. For example, the fraud report may indicate that a user's driver license was stolen or otherwise engaged in fraudulent activity. When updating the evaluations and rankings, evaluation subsystem 210 may associate the fraud report with prior validation result that involved the user's driver license. In some embodiments, the fraud report is received subsequent to the validation result (e.g., because there may be a delay in the user submitting the fraud report).

As an input for the evaluation model, the fraud report may impact the evaluation for a validation service provider. Consider an example scenario where a validation service provider successfully validates a document such as an alleged driver license and provides a successful validation result to evaluation subsystem 210. An evaluation model run subsequent to receiving this successful validation result may result in an increase in the ranking for the validation service provider. Later, a fraud report is generated when a user reports fraudulent activity associated with the alleged driver license. This fraud report, which includes the alleged driver license, may then be used as an input in a subsequent evaluation model. Because the alleged driver license was a fake but the validation service provider nonetheless provided a successful validation result, this would reduce the evaluation of the validation service provider for providing a false positive result. Similarly, in an example scenario where validation service provider had provided a failed validation result and consequently was ranked lower, the fraud report could indicate that the validation service provider had accurately not validated the document and the evaluation of the validation service provider would be updated accordingly for providing an accurate negative result.

In some embodiments, traffic adjustment subsystem 240 routes document validation requests based on the selection of one or more validation service providers. This routing may occur dynamically as documents are received by evaluation middleware system 200 from user devices. For example, traffic adjustment subsystem 240 may forward document validation requests based on the selection provided by evaluation subsystem 210 or may utilize the traffic adjustment parameter to select another service provider to service the document validation requests. In some embodiments, evaluation subsystem 210 may provide the selected validation service provider(s), the document to be validated, and another information associated with the document validation request to traffic adjustment subsystem 240.

In some embodiments, as part of the routing, traffic adjustment subsystem 240 may override the selected validation service provider and route the same document validation request to multiple validation service providers as indicated by the traffic adjustment parameter. For example, as discussed above, traffic adjustment parameters are used to vary selections of validation service providers such that the selection is not based solely on the rankings. In this manner, traffic adjustment subsystem 240 may replace the validation service provider selected by evaluation subsystem 210 with another service provider such as a lower ranked service provider, a service provider located in a lower tier, multiple service providers in the rankings such as all service provider or one service provider from each tier in the ranking.

Another example of overriding the selected validation service provider may include substituting the selected validation service provider with another validation service provider that is determined based on the traffic adjustment parameter. This override may be based on the traffic adjustment parameter indicating that the request should be sent to a lower ranked validation service provider.

In some embodiments, as part of the routing, when overriding the selected validation service provider, traffic adjustment subsystem 240 may send a request to evaluation subsystem 210 to provide additional validation service providers that satisfy the requirements of the traffic adjustment parameter. Traffic adjustment subsystem may request evaluation subsystem 210 to send, to name a few examples, (1) all document validation service providers, (2) a document validation service provider from each tier in the ranking, (3) a lower or lowest ranked document validation service provider, all of which are associated with a characteristic of the document to be validated and as indicated by the traffic adjustment parameter.

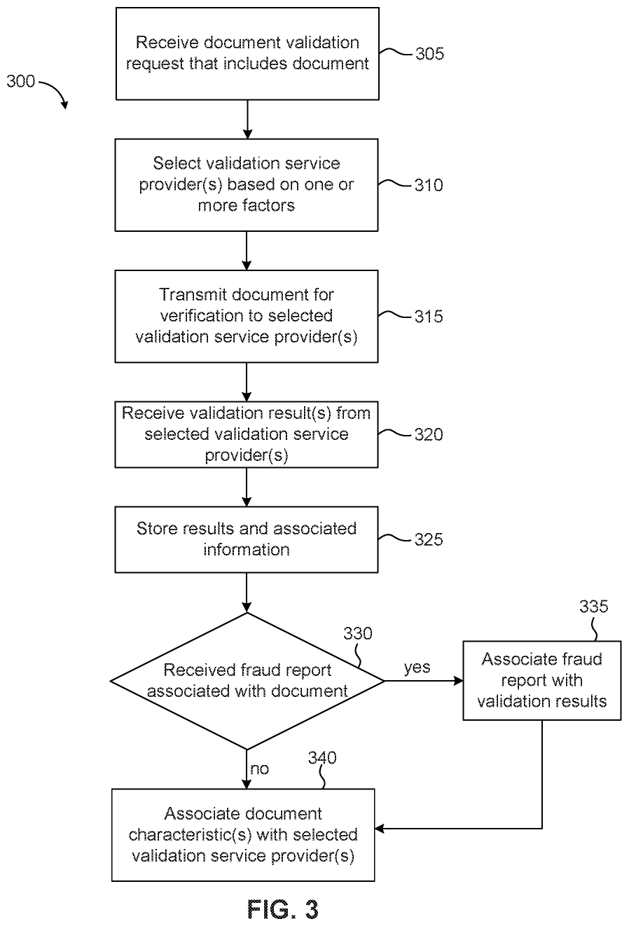

FIG. 3 depicts a flow diagram of an example method 300 for selecting a document validation service provider, according to some embodiments. As a non-limiting example with regards to FIGS. 1 and 2, one or more processes described with respect to FIG. 3 may be performed by an evaluation middleware system (e.g., evaluation middleware system 200 of FIG. 2) for selecting validation service providers for validating a document received from user device 110. In such an embodiment, evaluation middleware system 200 may execute code in memory to perform certain steps of method 300 of FIG. 3. While method 300 of FIG. 3 will be discussed below as being performed by evaluation middleware system 120, other devices including may store the code and therefore may execute method 300 by directly executing the code. Accordingly, the following discussion of method 300 will refer to devices of FIGS. 1 and 2 as an exemplary non-limiting embodiment of method 300. Moreover, it is to be appreciated that not all steps may be needed to perform the disclosure provided herein. Further, some of the steps may be performed simultaneously or in a different order than shown in FIG. 3, as will be understood by a person of ordinary skill in the art.

At 305, evaluation middleware system 120 may receive a document validation request from user device 110 that includes a document to be validated. The document validation request may be provided by a mobile application installed on user device 110. In some embodiments, the document validation request is transmitted from user device 110 subsequent to transmission, by user device 110, of a transaction request to conduct a transaction involving a user account associated with a user of user device 110. In some embodiments, evaluation middleware system 120 receives and processes the transaction request and issues an identity challenge. In other embodiments, evaluation middleware system 120 may forward the transaction request to another device operated by entity such as a bank that manages the user account to access account information of a user from a user device (e.g., the user device 110 of FIG. 1).

At 310, in response to response to receiving the document validation request, evaluation middleware system 120 may select one or more validation service providers. This selection may be based on any number of factors including, but not limited to, rankings associated with each validation service provider, the document and document information included in the document validation request, and/or a traffic adjustment parameter that indicates how much traffic should be forwarded to each validation service provider.

In some embodiments, validation service providers may be located on one or more rankings, such as a ranking based on all driver licenses and a ranking based on Ohio driver licenses specifically. Selection may be based on a validation service provider's ranking in each of these different rankings. For example, the ranking for each validation service provider in each ranking may be added together to produce a single value and the validation service provider with the highest value may be selected. In other embodiments, rankings may be weighted, such as more weight is placed on the ranking for all driver licenses.

In some embodiments, evaluation middleware system 120 may utilize a decision tree either alone or in combination with the ranking system described above. A decision tree is a type of supervised machine learning based on a known number of input variables and an output variable and the decision tree is used to determine the function that associates the input variables to the output variable. A decision tree may be utilized to determine (or even rank) the inputs based on their relationship with an output variable. For example, a decision tree may be used to determine that certain inputs, such as utilizing driver's licenses in a document validation request result in more positive validation results whereas social security cards result in more negative validation results. Evaluation middleware system 120 may utilize a decision tree based on the inputs (or a training set) to create the evaluation model that could enable better matching of the inputs to the validation service providers.

In some embodiments, document information may include but is not limited to, a device information, document type (e.g., word document, image file), and document properties. When the document is an image, these properties may include resolution of the image, depth information, brightness of the image, glare profile of the image, light color profile of the image, GPS location where image was taken place, information about the camera hardware used to capture the image, and information about the capture environment (e.g., kitchen, living room, table, indoors, outdoors). In some embodiments, these properties are provided by user device 110 such as through image capabilities of a mobile application such as by analyzing the image to determine the image properties and performing object detection in order to determine the capture environment.

At 315, evaluation middleware system 120 may transmit the document in document validation request to the selected validation service provider or providers. At 320, evaluation middleware system 120 may receive the validation result or results from the selected validation service provider or providers. At 325, evaluation middleware system 120 may then store the validation results and associated information later use (and retrieval) as inputs when generating or updating the evaluation model for the service providers.

At 330, evaluation middleware system 120 may determine whether a received fraud report is associated with the document in the document validation request received at 305. If yes, at 335, evaluation middleware system 120 may associate the fraud report with prior validation results. This association may be based on determining the document identified in the fraud report and then determining all prior validation results associated with the document. The fraud report may then be associated those determined prior validation results in preparation for updating the evaluation of the validation service providers associated with those prior validation results. If no, at 340, evaluation middleware system 120 may then associate the document characteristics and the validation results with the selected validation service provider(s) in preparation for updating the evaluation model.

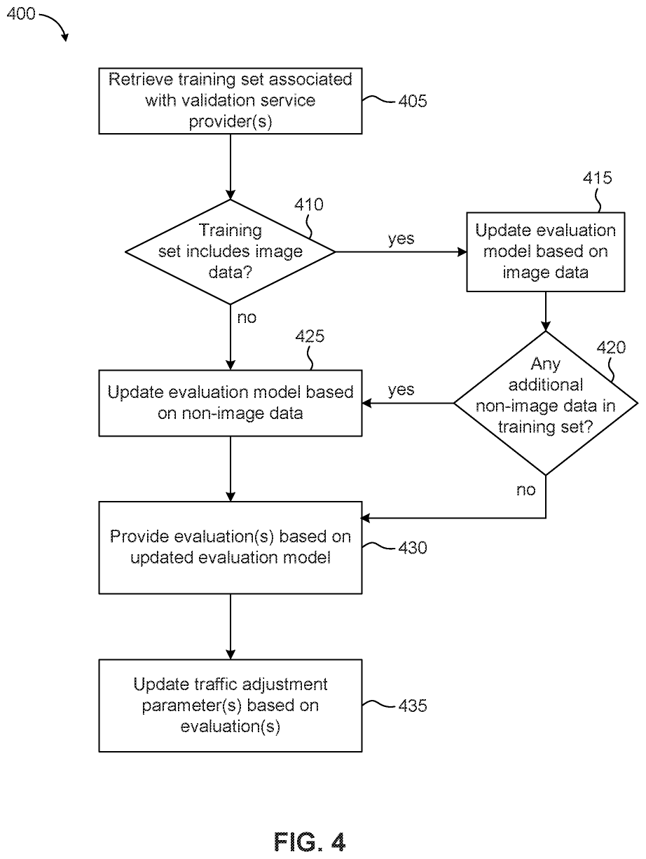

FIG. 4 depicts a flow diagram of an example method 400 for updating an evaluation model for multiple document validation service providers, according to some embodiments. As a non-limiting example with regards to FIGS. 1 and 2, one or more processes described with respect to FIG. 4 may be performed by an evaluation middleware system (e.g., evaluation middleware system 200 of FIG. 2) for selecting validation service providers for validating a document received from user device 110. In such an embodiment, evaluation middleware system 200 may execute code in memory to perform certain steps of method 400 of FIG. 4. While method 400 of FIG. 4 will be discussed below as being performed by evaluation middleware system 120, other devices including may store the code and therefore may execute method 400 by directly executing the code. Accordingly, the following discussion of method 400 will refer to devices of FIGS. 1 and 2 as an exemplary non-limiting embodiment of method 400.

At 405, evaluation subsystem 210 (or training subsystem 220) may receive a training set associated with one or more validation service providers. This training set may include information associated used to evaluate the performance of the validation service providers. For example, this information may include prior validation results provided by each validation service provider, documents associated with validation results, information associated with the documents, image information, and/or capture profiles provided by user devices.

At 410, evaluation subsystem 210 may determine whether the training set includes image data. If yes, at 415, image data from the training set may be provided for updating an evaluation model that is tuned for processing images. At 420, evaluation subsystem 210 may determine whether the training set includes non-image data such as prior validation results, document information, image information, and capture profiles.

If training set includes non-image data, at 425, the non-image data is provided for updating the evaluation model. In some embodiments, the evaluation model that receives the non-image data is tuned specifically for non-image data and is different from the evaluation model that receives the image data. In some embodiments, outputs of the evaluation models for image data and non-image data may then be used as inputs to a third evaluation model that outputs an update the rankings of validation service providers based on the evaluation of the image and non-image data.

At 430, the updated evaluation model(s) provide updated evaluation metrics of validation service providers and these updated metrics may also be used to update the rankings of the validation service providers. These rankings may be organized based on different document characteristics such as the document type, image information, among others as discussed above.

At 435, traffic adjustment subsystem 240 may then update a traffic adjustment parameter based on the updated evaluation metrics of validation service providers. For example, if the updated evaluation metrics results in changes to the ranking of validation service providers (e.g., the previously highest ranked service provider is lower in the rankings and the third ranked service provider is now the highest ranked service provider). This change in the rankings may result in changing the traffic adjustment parameter such that the traffic is routed based on the new rankings to the validation service providers.

FIG. 5 depicts an example computer system useful for implementing various embodiments.

Various embodiments may be implemented, for example, using one or more well-known computer systems, such as computer system 500 shown in FIG. 5. One or more computer systems 500 may be used, for example, to implement any of the embodiments discussed herein, as well as combinations and sub-combinations thereof.

Computer system 500 may include one or more processors (also called central processing units, or CPUs), such as a processor 504. Processor 504 may be connected to a communication infrastructure or bus 506.

Computer system 500 may also include user input/output device(s) 503, such as monitors, keyboards, pointing devices, etc., which may communicate with communication infrastructure 506 through user input/output interface(s) 502.

One or more of processors 504 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 500 may also include a main or primary memory 508, such as random access memory (RAM). Main memory 508 may include one or more levels of cache. Main memory 508 may have stored therein control logic (i.e., computer software) and/or data.

Computer system 500 may also include one or more secondary storage devices or memory 510. Secondary memory 510 may include, for example, a hard disk drive 512 and/or a removable storage device or drive 514. Removable storage drive 514 may be a floppy disk drive, a magnetic tape drive, a compact disk drive, an optical storage device, tape backup device, and/or any other storage device/drive.

Removable storage drive 514 may interact with a removable storage unit 518.

Removable storage unit 518 may include a computer usable or readable storage device having stored thereon computer software (control logic) and/or data. Removable storage unit 518 may be a floppy disk, magnetic tape, compact disk, DVD, optical storage disk, and/any other computer data storage device. Removable storage drive 514 may read from and/or write to removable storage unit 518.

Secondary memory 510 may include other means, devices, components, instrumentalities or other approaches for allowing computer programs and/or other instructions and/or data to be accessed by computer system 500. Such means, devices, components, instrumentalities or other approaches may include, for example, a removable storage unit 522 and an interface 520. Examples of the removable storage unit 522 and the interface 520 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 500 may further include a communication or network interface 524. Communication interface 524 may enable computer system 500 to communicate and interact with any combination of external devices, external networks, external entities, etc. (individually and collectively referenced by reference number 528). For example, communication interface 524 may allow computer system 500 to communicate with external or remote devices 528 over communications path 526, which may be wired and/or wireless (or a combination thereof), and which may include any combination of LANs, WANs, the Internet, etc. Control logic and/or data may be transmitted to and from computer system 500 via communication path 526.

Computer system 500 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 500 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 500 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 500, main memory 508, secondary memory 510, and removable storage units 518 and 522, as well as tangible articles of manufacture embodying any combination of the foregoing. Such control logic, when executed by one or more data processing devices (such as computer system 500), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 5. In particular, embodiments can operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The breadth and scope of the present invention should not be limited by any of the above-described exemplary embodiments, but should be defined only in accordance with the following claims and their equivalents.

1. A method for dynamic service provider selection for document validation, comprising:
receiving, by an evaluation middleware system over a first network connection from a plurality of validation service providers, a plurality of validation results, wherein a validation result of the plurality of validation results is received from a respective validation service provider of the plurality of validation service providers and responsive to a respective document validation request transmitted to the respective validation service provider, and wherein the respective document validation request is associated with a document characteristic;
training, by the evaluation middleware system, an evaluation model based on the plurality of validation results by:
linking the respective document validation request to the validation result;
generating an evaluation of the respective validation service provider of the plurality of validation service providers for the document characteristic based on the linking; and
generating a ranking of the plurality of validation service providers based on the evaluation;
receiving, by the evaluation middleware system from an application on a user device over a second network connection, a document validation request including an image of a document;
extracting, by the evaluation middleware system, from the image the document characteristic associated with the document; selecting, by the evaluation middleware system and based on the trained evaluation model and the document characteristic, a validation service provider of the plurality of validation service providers; and
routing, by the evaluation middleware system over the first network connection, the document validation request to the selected validation service provider based on the selecting.

2. The method of claim 1, further comprising:
receiving, responsive to routing the document validation request, another validation result from the selected validation service provider; and
updating the trained evaluation model based on the another validation result.

3. The method of claim 2, further comprising:
updating the trained evaluation model based on the at least one document characteristic and the another validation result.

4. The method of claim 2, wherein the evaluation model comprises a first level evaluation model for evaluating the at least one document characteristic and a second level evaluation model for evaluating the image of the document, the method further comprising:
providing, to the first level evaluation model, the at least one document characteristic;
providing, to the second level evaluation model, the image of the document; and
updating, by the trained evaluation model and based on the at least one document characteristic, the another validation result, and the image of the document.

5. The method of claim 2, wherein the another validation result indicates a successful validation of the document, an unknown validation of the document, or a failed validation of the document.

6. The method of claim 1, wherein the at least one document characteristic includes at least one of: a document type and information associated with the user device.

7. The method of claim 1, wherein the at least one document characteristic includes image information associated with the first document including at least one of a location associated with the document, the image, a glare profile, or a color profile.

8. The method of claim 7, wherein the application of the user device processes the document to produce the image information.

9. The method of claim 1, the method further comprising:
receiving a fraud report associated with the first document;
providing, to the trained evaluation model, the fraud report;
determining that the another validation result is a false positive based on a comparison between the validation result with a result in the fraud report; and
updating, by the trained evaluation model and based on determining that the validation result is a false positive, an evaluation of the selected validation service provider.

10. The method of claim 1, wherein the evaluation includes an evaluation metric and selecting the validation service provider comprises:
determining that the evaluation metric is lower than another evaluation metric of another validation service provider; and
identifying the selected validation service provider responsive to the evaluation metric being lower than the another evaluation metric.

11. The method of claim 1, further comprising:
issuing, to the application on the user device, an identification challenge, wherein the document validation request is routed responsive to the identification challenge.

12. A non-transitory computer-readable medium storing instructions, the instructions, when executed by a processor at an evaluation middleware system, cause the processor to perform operations comprising:
receiving, over a first network connection, a plurality of validation results from a plurality of validation service providers, wherein a validation result of the plurality of validation results is received from a respective validation service provider of the plurality of validation service providers and responsive to a respective document validation request transmitted to the respective validation service provider, and wherein the respective document validation request is associated with a first document characteristic and a second document characteristic;
training an evaluation model based on the plurality of validation results by:
linking the respective document validation request to the validation result;
generating a first evaluation of the respective validation service provider for the first document characteristic based on the linking;
generating a second evaluation of the respective validation service provider for the second document characteristic based on the linking; and
generating a first ranking and a second ranking of the respective validation service providers based on the first and second evaluations;
receiving, over a second network connection from a user device, a document validation request including an image of a document;
extracting, from the image, the first document characteristic and the second document characteristic associated with the document;
selecting, based on the first ranking and the second ranking, a validation service provider of the plurality of validation service providers;
routing, over the first network connection and based on the selecting, the document validation request to the selected validation service provider.

13. The non-transitory computer-readable medium of claim 12, further comprising:
receiving, responsive to routing the document validation request, another validation result from the selected validation service provider;
updating the first evaluation, by the evaluation model, based on the first document characteristic and the another validation result; and
associating the another validation result with the first document characteristic.

14. The non-transitory computer-readable medium of claim 13, further comprising:
updating, by the evaluation model and based on the first document characteristic and the second document characteristic, and the validation result, the first evaluation and the second evaluation.

15. The non-transitory computer-readable medium of claim 13, further comprising:
receiving a fraud report associated with the document;
providing, to the evaluation model, the fraud report; and
updating, by the evaluation model and based on the fraud report, the first evaluation and the second evaluation.

16. The non-transitory computer-readable medium of claim 12, wherein selecting the validation service provider further comprises:
providing an evaluation metric based on the first ranking and the second ranking.

17. The non-transitory computer-readable medium of claim 12, wherein the first document characteristic includes a document type or information associated with the user device.

18. The non-transitory computer-readable medium of claim 12, wherein the first document characteristic includes image information associated with the document including at least one of a location associated with the document, the image, a glare profile, or a color profile.

19. The non-transitory computer-readable medium of claim 12, wherein the first evaluation includes an evaluation metric and selecting the validation service provider comprises:
determining that the evaluation metric is lower than another evaluation metric of another validation service provider; and
identify the selected validation service provider responsive to the evaluation metric being lower than the another evaluation metric.

20. An apparatus for dynamic service provider selection for document validation, comprising:
a memory; and
a processor communicatively coupled to the memory and configured to:
receive, over a first network connection, a plurality of validation results from a plurality of validation service providers, wherein a validation result of the plurality of validation results is received from a respective validation service provider of the plurality of validation service providers and responsive to a respective document validation request transmitted to the respective validation service provider, and wherein the respective document validation request is associated with a document characteristic;
train an evaluation model based on the plurality of validation results by:
linking the respective document validation request to the validation result;
generating an evaluation of the respective validation service provider for the document characteristic based on the linking; and
generating a ranking of the plurality of validation service providers based on the evaluation;
receive, over a second network connection, a document validation request wherein the document validation request includes an image of a document;
extract, from the image, the document characteristic associated with the document;
select, based on the trained evaluation model, a validation service provider of the plurality of validation service providers;
route, over the first network connection and based on the selecting, the document validation request to the selected validation service provider;
receive, over the first network connection and responsive to routing the document validation request, another validation result from the selected validation service provider; and
update the evaluation model based on the another validation result and the at least one document characteristic.
